(19) United States
(12) Patent Application Publication
(10) Pub. No.: US 2002/0169720 A1
(43) Pub. Date: Nov. 14, 2002

(54) Method for cardholder to place use restrictions on credit card at will

(76) Inventors: Phillip C. Wilson, Villanova, PA (US); Donald H. Wilson, Philadelphia, PA (US)

Correspondence Address: PHILLIP C. WILSON, 756 CAMP WOODS ROAD, VILLANOVA, PA, 19087, US

(21) Appl. No.: 09/853,908

(22) Filed: May 12, 2001

(51) Int. Cl. G06F 17/60

(52) U.S. Cl. 705/44; 705/39

(57) ABSTRACT

A method for cardholders to communicate restrictions on card usability in terms of time, amount, number of charges, and merchants to card issuers though dedicated applications on wireless PDA, cell phone, desktop applications, or Web applications, repeatedly and at will, and for card issuers to evaluate future transactions in terms of these restrictions and authorize or decline those transactions based on the results of those evaluations.

### FIELD OF THE INVENTION

The present invention relates to a method of fraud protection by which the holder of a credit account, bank debit account, telephone calling account, or other account can make the account active or inactive repeatedly and at will.

### BACKGROUND OF THE INVENTION

When a cardholder purchases goods or services from a retail establishment, on-line, by mail order, or from other merchants, account information (at a minimum, the card number and expiration date) is given to the merchant, either on the physical card, or, in the case of telephone-based transactions, verbally by the cardholder, or, in the case of Web-based transactions, electronically through a browser, or by other means. That information, along with other information (at a minimum, merchant number and amount charged) is transmitted to the card issuer, usually by way of a clearinghouse.

Card fraud is widespread, with many millions of dollars in fraudulent charges being made every year. Fraudulent use of a card can occur when the physical card or card number is stolen. Typically, anti-counterfeiting indicia, such as holograms, photographs or signatures, may appear on the card to discourage wrongful usage. However, these approaches put the onus on the merchant to be vigilant in checking these indicia.

A number of attempts to create automated solutions to the problem of card fraud appear in the prior art. An early example of an anti-counterfeiting solution is U.S. Pat. No. 4,034,211 entitled SYSTEM AND METHOD FOR PROVIDING A SECURITY CHECK ON A CREDIT CARD. This patent describes a system whereby a card is encoded with a set of unique data stored on optical gratings and standard card data is stored on a magnetic stripe. When the card is swiped, a reference to the first data set is included in the transmission. This reference is decoded by the issuer and compared to the first set of data to confirm that the card is not fraudulent.

However, transactions where the physical card is not required are becoming increasingly common with the rise in mail-order and Internet-based retailers. Thus, anti-counterfeiting indicia on the physical card are not useful in preventing fraud in these transactions. In an example of a solution for transactions when a physical card is not present, U.S. Pat. No. 5,311,594 entitled FRAUD PROTECTION FOR CARD TRANSACTIONS requires that the person engaged in a card transaction present additional authentication information in the form of a randomly selected pre-stored piece of information or information derived from a randomly selected piece of information. The transaction will only be authorized if the additional authentication information is correctly presented. Because the selection of the pre-stored information is random between one transaction and the next, a thief will not be able to use the information from a previous transaction to engage in additional transactions.

Similarly, U.S. Pat. No. 6,095,413 entitled SYSTEM AND METHOD FOR ENHANCED FRAUD DETECTION IN AUTOMATED ELECTRONIC CREDIT CARD PROCESSING describes a system whereby the card user must supply, in addition to the credit card information, an address and social security number. The authenticated address(es) and social security card number of the authorized user are stored in two separate databases, and both must be confirmed in order for the transaction to be authorized. U.S. Pat. No. 5,988,497 entitled METHOD FOR AUTHENTICATING CREDIT TRANSACTIONS TO PREVENT FRAUDULENT CHARGES describes a system whereby a cardholder is required to provide at least one and possibly two personal identification numbers in order for a transaction to be authorized.

U.S. Pat. No. 6,188,309 entitled METHOD AND APPARATUS FOR MINIMIZING CREDIT CARD FRAUD goes further by describing an intelligent card which provides a means for the cardholder to input a personal identification number directly into the card, which will be verified directly by the card. Based on this verification, the card will activate the card number output device (magnetic strip) and allow the transaction to be performed.

Occurrences of credit card fraud have increased significantly with the advent of e-commerce, with a significant percentage of the increase in charge-backs over recent years attributable to on-line credit card fraud. Therefore, other implementations have focused on the particular characteristics of telephone or on-line transactions, where merchants have limited access to additional authenticating information in the event that a fraud claim is brought by a cardholder and/or card issuer. U.S. Pat. No. 6,108,642 entitled DEVICE FOR SELECTIVELY BLOCKING REMOTE PURCHASE REQUESTS describes a system to be used with remote credit card purchases via telephone or Web browser, whereby the merchant will maintain a database of prior credit card purchase information, including origin, consisting of a computer I.P. address or a telephone number. A transaction may be authorized or declined by the merchant based on whether it meets specific criteria with regards to a comparison to previous transactions with the same credit card number.

U.S. Pat. No. 6,163,771 entitled METHOD AND DEVICE FOR GENERATING A SINGLE-USE FINANCIAL ACCOUNT NUMBER goes further in addressing the opportunities for fraud by providing a method and device for generating a single-use financial account number based on previously-selected data elements which are used to generate the single-use financial account number by means of an encryption algorithm. This account number, when decrypted, allows the card issuer to verify the underlying data elements used to generate the number.

These approaches all place the burden of reducing fraud on the merchant or card issuer at the time of the transaction. One advantage of the present invention is that it provides a means for cardholders to preemptively limit the opportunities for credit cards and credit card numbers to be used fraudulently, by allowing cardholders to directly control whether the card is active (i.e., useable), and for which dollar amount(s), duration(s) of time, number of charges, and/or merchants.

Furthermore, many of the above inventions focus on authenticating the identity of the cardholder, based on static information about the cardholder. It is conceivable that this information could be known or collected by an unauthorized third party, which, in combination with a card number, would allow the fraudulent use of a card. Another advantage of the present invention is that by allowing cardholders to make credit cards active or inactive at will, it reduces the need to rely on inherently weak identity authentication as the primary means of eliminating fraud.

Other limitations of the inventions referenced above are: by requiring additional information to be transmitted to the card issuer, they are unable to work within the parameters of current electronic transaction authorization technology, which is presently configured to transmit a 15 or 16 digit card number, a four digit expiration date, and optionally numeric portions of an address; they require that the cardholder use additional devices; or they require that the cardholder remember additional information. A further advantage of the present invention is that it does not require any changes to the existing system for making credit card purchases on the part of the merchant or the cardholder.

What is needed is a method by which card transactions can be made more secure against fraud, which is not prohibitively expensive to implement, does not require changes to the existing hardware infrastructure used to process transactions, and is simple enough to use that it will be widely adopted by cardholders.

### BRIEF DESCRIPTION OF THE INVENTION

The present invention provides a method by which cardholders can control repeatedly and at will, the active/inactive state of an account, and define amounts, merchants, number of charges, and/or periods of time for which the card will be active (i.e., useable), and by which card issuers can reject authorization attempts which do not conform to one or more of the cardholder's use restrictions. For the purposes of this invention, the term “card” refers to credit accounts, bank debit accounts, telephone calling accounts, and other accounts whether a physical card is associated with the account or not, and the term “cardholder” refers to an authorized user of said accounts.

This method is comprised of a dedicated cardholder application and a dedicated card issuer application. The cardholder application, running on or accessible through a desktop computer, wireless PDA, telephone (including smart-card enabled telephones), cell phone, or Web browser, performs the following functions:

Allows a cardholder to turn a card on or off for a defined period of time, for a specified number of charges, for a specified merchant, and/or for a specified individual or aggregate dollar amount, (“use restrictions”);

Transmits these use restrictions preferably in an encrypted, digitally signed, and time-stamped format to the card issuer; and

Allows a cardholder to receive transaction histories from the card issuer, including successful authorizations and failed authorization attempts. It further allows the cardholder to verify the current status of a credit card with the card issuer.

The card issuer application, running on or accessible through the card issuer's computer performs the following functions when an authorization attempt is made:

Determines whether the attempted transaction conforms to the use restrictions defined by the cardholder;

Rejects the attempted transaction if it does not conform to any of the use restrictions; and

records authorized and rejected transactions to a transaction history database for review by the cardholder.

### OBJECTS OF THE INVENTION

There are two important objectives of this invention. The first is to reduce opportunities for card fraud by providing additional controls on how a card can be used: when it can be active, how much can be charged to it, and at which merchants it can be used. The second objective is to increase consumer confidence in the security of their credit cards and thereby increase their willingness to use credit cards to make on-line purchases.

In order to achieve these objectives, it is an object of this invention to provide multiple means for a cardholder to communicate restrictions on the use of a card to the card issuer. These means include a dedicated application running on a wireless PDA or cell phone, a dedicated desktop application using an Internet connection, a dedicated Web application accessed through an Internet browser, and a telephone connection.

It is a further object of this invention to provide means for the cardholder to set the restrictions that will be placed on the card. These restrictions include one or more of the following: reject all transactions, reject transactions that take place during one or more specified time periods, reject transactions that exceed a specified amount, reject transactions that exceed a specified total dollar amount during a specified period of time, reject transactions that exceed a specified number of transactions during a specified period of time, reject transactions originating from a specified set of merchants, and reject transactions that do not originate from a specified set of merchants.

It is a further object of this invention that the card issuer be able to store the use restrictions defined by the cardholder in a database and have these restrictions applied in conjunction with existing procedures to authorize or deny transaction requests.

It is a further object of this invention that the cardholder will be able to monitor the use of the card in real-time by having each transaction and/or transaction attempt reported back to the cardholder from the card issuer.

It is a further object of this invention that the cardholder be able to verify the current use restrictions of each card with the card issuer at any time.

It is a further object of this invention that the cardholder be able to use a single instance of the desktop application to place restrictions on multiple cards and communicate with multiple card issuers.

### BRIEF DESCRIPTION OF THE FIGURES

The accompanying drawings are for illustrative purposes only:

FIG. 1 shows the cardholder using a computer with a program to transmit a Use Restriction Record to the Use Restriction Database at the card issuer location.

FIG. 2 shows the data fields contained in a Use Restriction Record of the preferred embodiment.

FIG. 3 shows the data fields in the tables in the Use Restriction Database of the preferred embodiment.

FIG. 4 shows the process by which the card issuer approves or rejects a transaction in the preferred embodiment.

FIG. 5 shows the data fields contained in a Transaction Record of the preferred embodiment.

FIG. 6 is a flowchart that shows the process the Card Issuer Program uses to authorize or deny a transaction in the preferred embodiment.

### DETAILED DESCRIPTION OF THE PREFERRED EMBODIMENT OF THE INVENTION

The following description of the preferred embodiment of this invention is provided to enable any person skilled in the art to make and use the invention and sets forth the best modes contemplated by the inventors of carrying out their invention. Various modifications, however, will remain readily apparent to those skilled in the art, since the general principles of the present invention have been defined herein specifically to provide enhanced fraud detection in automated electronic card processing.

Presently, when a cardholder receives a new credit card, the card is inactive until such time as the cardholder calls a specified number to activate the card, authenticating his or her identity by either calling from the home phone specified on the credit card application, or by providing other information specified on the card application, such as mother's maiden name, birth date, or social security number. Once activated, a card will remain active as long as it is not reported lost or stolen, has not expired, and as long as the cardholder's account is in good standing (i.e., payments are up-to-date and, if applicable, the credit limit has not been exceeded). If any of these criteria are not met, the card issuer may make the card temporarily or permanently inactive.

The present invention provides a method by which cardholders can control repeatedly and at will, the active/inactive state of an account, and define amounts, merchants, number of charges, and/or periods of time for which the card will be active (i.e., useable), and by which card issuers can reject authorization attempts which do not conform to one or more of the cardholder's use restrictions. This card may be a credit account, a debit account (e.g., a bank card), or a service account (e.g., an account associated with a telephone calling card, a library card, a video rental card, etc.).

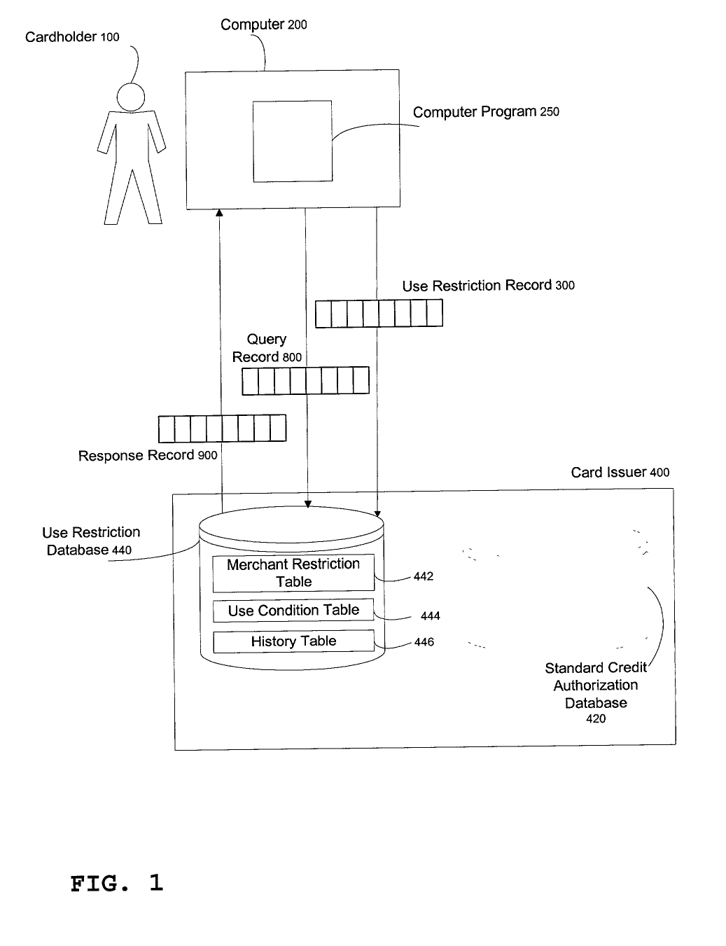

As shown on FIG. 1, using Computer Program 250 installed on Computer 200, Cardholder 100 will create Use Restriction Record 300, which may include quantitative and qualitative criteria, and transmit it to Use Restriction Database 440 located at Card Issuer 400. In order to transmit Use Restriction Record 300, Cardholder 100 makes use of a password to confirm identity. The term “password” refers to an alphanumeric identifier composed of one or more characters, a unique biometric identifier such as those based on voice, fingerprint or eye scans, and/or an encryption scheme wherein data is encrypted and decrypted using encryption keys.

All record, table, database structures, and field sizes are only exemplary, and are provided in order to facilitate the explanation of the preferred embodiment. The actual record, table, and database structures will be determined by the features of the invention.

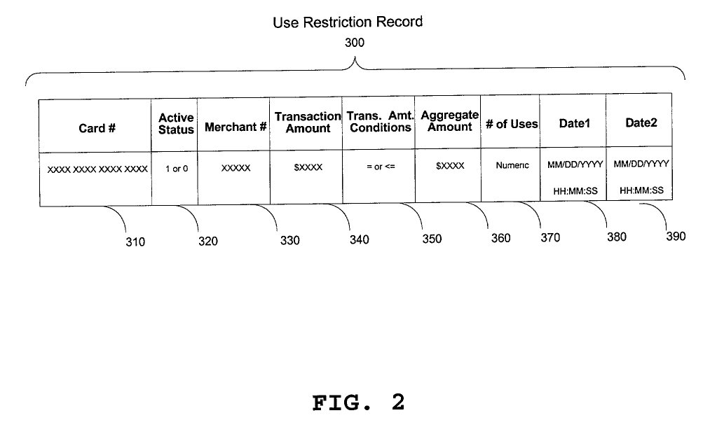

As shown in FIG. 2, Use Restriction Record 300 consists of the following fields:

Card Number 310, a required field allowing alphanumeric values of up to 16 digits;

Active Status 320, a required field allowing True/False values of “1” and “0” respectively;

Merchant Number 330, allowing alphanumeric values of 5 digits, or blank;

Transaction Amount 340, allowing numeric values equaling the dollar amount of a single transaction, or blank;

Transaction Amount Conditions 350, allowing the Boolean values “=” or “<=”, or blank;

Aggregate Amount 360, allowing numeric values equaling the aggregate dollar amount of all transactions posted on or after the date of the current Use Restriction Record 300, or blank;

Number of Uses 370, allowing numeric values equaling the number of uses for a card, or a unique combination of Merchant and Transaction Amount (hereafter called “merchant restriction record”), or blank;

Date1 380 allowing date/time values in the format MM/DD/YYYY HH:MM:SS;

Date2 390 allowing date/time values in the format MM/DD/YYYY HH:MM:SS.

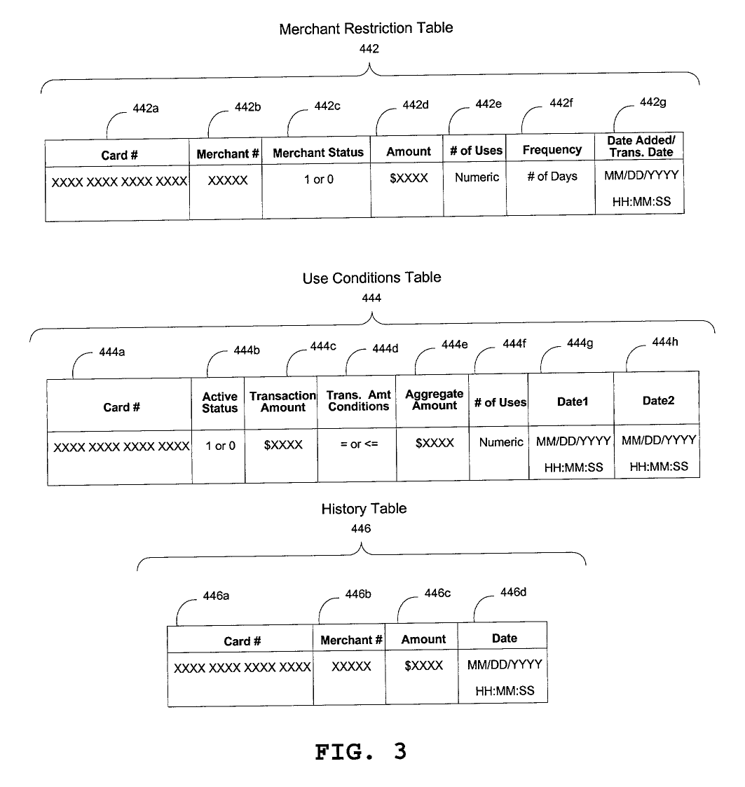

Cardholder 100 will use Computer Program 250 installed on Computer 200 to generate Use Restriction Record 300. The data contained in Use Restriction Record 300 will be stored at the Use Restriction Database 440 at the card issuer location. As shown in FIG. 3, this database consists of Merchant Restrictions Table 442, Use Condition Table 444, and History Table 446, and possibly others.

Use Restriction Record 300 will be created in the manner described in the following examples, which are merely exemplary and do not represent an exhaustive list of possible uses:

In order to activate or deactivate a card, Cardholder 100 will use Computer Program 250 to set values for Card Number 310 and Active Status 320, such that when the value of Active Status 320 is “1” the card will be active, and when the value of Active Status 320 is “0” the card will be inactive. By means of processes incorporated into Computer Program 250 and Use Restriction Database 440, these values will be written to the corresponding fields Card Number 444a and Active Status 444b in Use Condition Table 444 in Use Restriction Database 440 (FIG. 3).

If Cardholder 100 wishes to authorize a card for transactions less than or equal to a specific dollar amount, Cardholder 100 will use Computer Program 250 to set values for the fields Card Number 310, Active Status 320, Transaction Amount 340, Transaction Amount Conditions 350, and optionally, Date1 380 and Date2 390, if Cardholder 100 wishes to impose a time period for the condition. By means of the processes referred to above, these values will be written to the corresponding fields Card Number 444a, Active Status 444b, Transaction Amount 444c, Transaction Amount Conditions 444d, Date1 444g, and Date2 444h in Use Condition Table 444 in Use Restriction Database 440 (FIG. 3).

If Cardholder 100 wishes to authorize a card for a unique merchant/amount combination, Cardholder 100 will use Computer Program 250 to set values for the fields Card Number 310, Merchant Number 330, Transaction Amount 340, and Date1 380. Optionally, for recurring transactions, Cardholder 100 can set a number of uses or frequency in field Number of Uses 370. By means of the processes referred to above, these values will be written to the corresponding fields Card Number 442a, Merchant Number 442b, Amount 442d, Date Added/Transaction Date 442g, and, optionally, Number of Uses 442e or Frequency 442f in the Merchant Restrictions Table 442 in Use Restriction Database 440 (FIG. 3).

Other possible conditions Cardholder 100 could place on a card include restricting a card to an aggregate amount from a date forward, restricting a card to a number of uses from a date forward, deactivating a card for a specific merchant, and activating the card for a particular number of days, hours, or minutes.

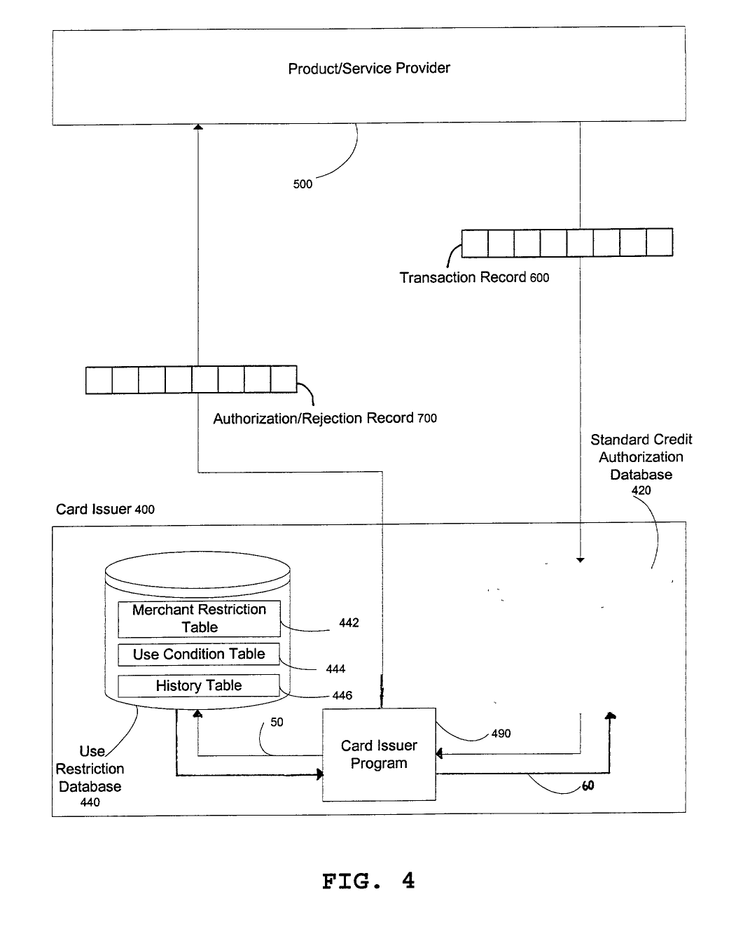

The process by which a transaction is authorized is shown in FIG. 4. During the course of a card transaction, Product/Service Provider 500 will transmit Transaction Record 600 to Standard Credit Authorization Database 420 for authorization. Once the transaction record is authorized by the Standard Credit Authorization Database 420, the Transaction Record 600 is sent to Card Issuer Program 490 where the restrictions contained in the Use Restriction Database 440 are applied and an Authorization/Rejection Record 700 is sent back to the Product/Service Provider 500. For the purposes of this illustration, the Standard Credit Authorization Database 420 and Use Restriction Database 440 are shown as separate databases, which can either be in the same or different locations; however, it is possible that they could be combined into a single database.

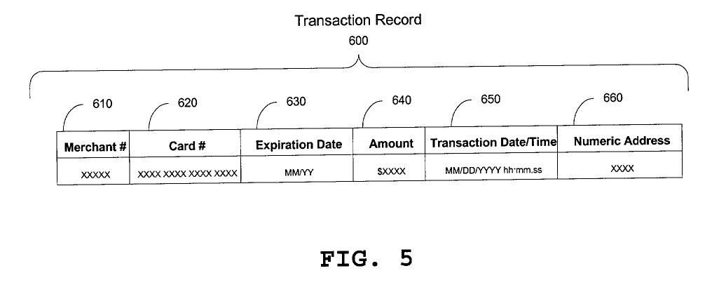

FIG. 5 indicates that the information contained in Transaction Record 600 will be Merchant Number 610, Card Number 620, Expiration Date 630, Amount 640, Transaction Date/Time 650, and optionally, Numeric Address 670.

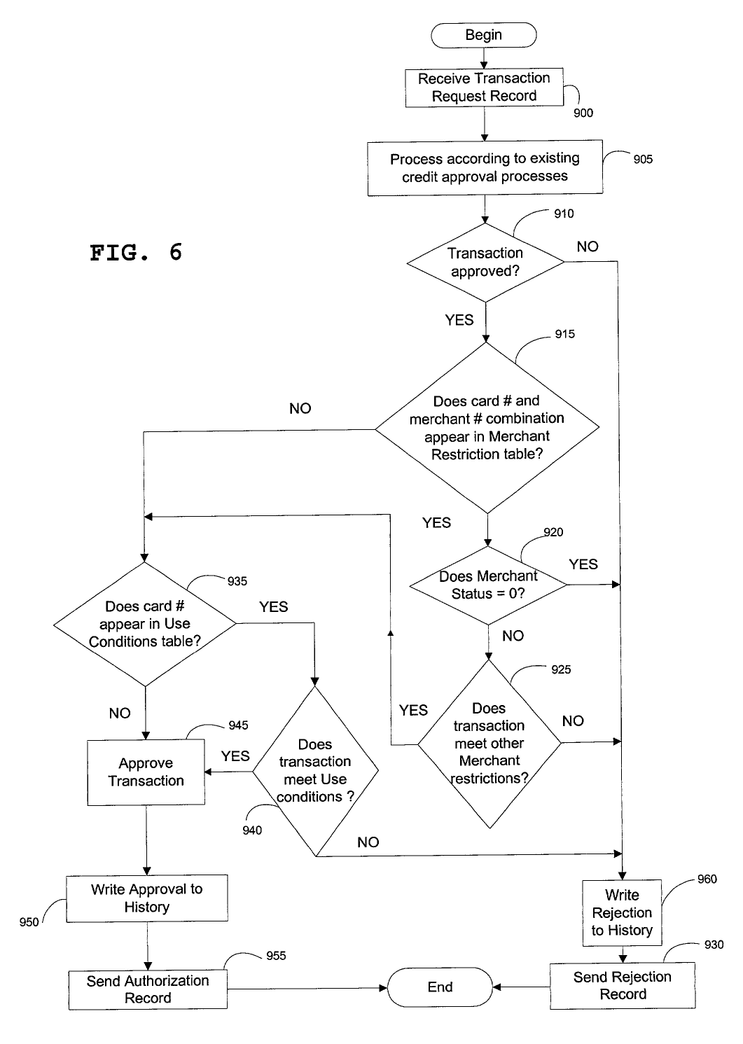

FIG. 6 outlines the process that Card Issuer 400 will use to determine whether Transaction Record 600 should be authorized. Card Issuer will receive Transaction Record 600 (block 900 of FIG. 6), and process Transaction Record 600 according to existing approval processes (block 905) using Standard Credit Authorization Database 420 (i.e., a process to verify that card has not been reported as stolen or lost and that the account is in good standing). If Transaction Record 600 is not approved (block 910—NO), the Card Issuer Program 490 will proceed to write the record to History Table 446 (block 960), which henceforth shall mean the data contained in Transaction Record 600 will be written to the corresponding fields in History Table 446 of Use Restriction Database 440 as either an approved or rejected record. The Card Issuer Program 490 will then send a rejection record (block 930).

If Transaction Record 600 is approved (block 910—YES), the Card Issuer Program 490 will check whether the card number and merchant number combination appears in Merchant Restriction Table 442 of Use Restriction Database 440 (block 915). If the card number and merchant number combination does appear in Merchant Restriction Table 442 (block 915—YES), the Card Issuer Program 490 will check whether Merchant Status 442c is set to false (block 920). If Merchant Status 442c is false (block 920—YES), the Card Issuer Program 490 will proceed to write a record to History Table 446 (block 960) and send a rejection record (block 930). If Merchant Status 442c is not false (block 920—NO), the Card Issuer Program 490 will determine whether Transaction Record 600 meets other restrictions in Merchant Restriction Table 442 (e.g., dollar amount, number of uses, frequency of use).

If Transaction Record 600 does not meet these restrictions, the Card Issuer Program 490 will proceed to write a record to History Table 446 (block 960) and send a rejection record (block 930).

If Transaction Record 600 does meet these restrictions, or if the card number and merchant number combination does not appear in Merchant Restriction Table 442, the Card Issuer Program 490 will check whether the card number in Transaction Record 600 appears in Use Conditions Table 444 (block 935). If the card number does not appear in Use Conditions Table 444, the Card Issuer Program 490 will proceed to approve the transaction (block 945), and will write a record to History Table 446 (block 950), and send an authorization record (block 955).

If the card number does appear in Use Conditions Table 444, the Card Issuer Program 490 will determine whether Transaction Record 600 meets the use conditions (block 940)(e.g., active status, transaction amount, aggregate amount, number of uses, use within a specified time frame). If it does not meet the use conditions, the Card Issuer Program 490 will write a record to History Table 446 (block 960) and send a rejection record (block 930). If it does meet the use conditions, the Card Issuer Program 490 will proceed to approve the transaction (block 945), write a record to History Table 446 (block 950), and send an authorization record (block 955).

Based on the above, as shown in FIG. 4, the Card Issuer Program 490 will issue a Rejection/Authorization Record 700 for Transaction Record 600.

As shown in FIG. 1, Cardholder 100 may also use Computer Program 250 installed on Computer 200 to submit Query Record 800 to Use Restriction Database 440. Possible queries would include card status, balance remaining, recent charges, and recent transaction attempts, either approved, rejected, or both. Use Restriction Database 440 will return Response Record 900 to Computer Program 250 such that Cardholder 100 will be able to view the data contained therein.

The foregoing merely illustrates the principles of the invention. Those skilled in the art will be able to devise various arrangements which, although not explicitly described herein, embody the principals of the invention and are thus within its spirit and scope.

### CONCLUSION, RAMIFICATIONS, AND SCOPE OF INVENTION

Thus, the reader will see that the method of the present invention allows cardholders to control whether their cards are active or inactive on an on-going basis, thereby significantly reducing the opportunities for fraudulent use of those cards.

While the above description contains much specificity, these should not be construed as limitations on the scope of the invention, but rather as an exemplification of one preferred embodiment thereof. Many other variations are possible, for example a method by which a cardholder can qualitatively control use of their cards for individual items (e.g. particular book titles, music titles, video titles.) based on a rating system. Accordingly, the scope of the invention should be determined not by the embodiment illustrated, but by the appended claims and their legal equivalents.

What is claimed is:

1) A method for use in authorizing a transaction for a particular account, comprising the steps of:
(a) instructing one or more restrictive criteria by an account holder authorized to charge transactions for said account; and
(b) validating an attempted transaction for said account responsive to said criteria;
whereby said attempted transaction will be authorized only if said transaction conforms with said criteria instructed by said account holder.

2) The method of claim 1 further comprising the step of providing a password that enables said account holder to provide said criteria.

3) The method of claim 1 wherein the attempted transaction further comprises providing an account number to a product/service provider.

4) The method of claim 1 wherein step (a) further comprises transmitting said criteria to a criteria processing facility.

5) The method of claim 1 wherein step (b) further comprises the steps of:
(a) transmitting said account number to a criteria processing facility;
(b) processing said transaction against said criteria instructed by said account holder;
(c) accepting or rejecting said transaction responsive to said criteria.

6) The method of claim 1 wherein said account is a credit account.

7) The method of claim 1 wherein said account is a debit account.

8) The method of claim 1 wherein said account is a service account.

9) The method of claim 3 wherein the step of providing an account number comprises transmitting said account number to said product/service provider over a network.

10) The method of claim 9 wherein said account number is transmitted over a telephone network.

11) The method of claim 9 wherein said account number is transmitted over a wireless network.

12) The method of claim 9 wherein said account number is transmitted over a computer network.

13) The method of claim 1 wherein said criteria includes a time and date range for acceptable transactions.

14) The method of claim 1 wherein said criteria includes a list of merchants to be accepted or rejected.

15) The method of claim 1 wherein said criteria includes a limit of total transaction dollar amounts on said account.

16) The method of claim 15 wherein said limit includes a single transaction.

17) The method of claim 15 wherein said limit includes multiple transactions over an interval of time.

18) A method for use in authorizing a transaction for a particular credit card account, comprising the steps of:
(a) instructing one or more restrictive criteria by an account holder authorized to charge transactions for said account;
(b) transmitting said criteria to a criteria processing facility;
(c) initiating an attempted transaction for said account by providing an account number to a product/service provider over a computer network;
(d) transmitting said account number to said criteria processing facility;
(e) validating said attempted transaction for said account responsive to said criteria;
whereby said attempted transaction will be authorized only if said transaction conforms with said criteria instructed by said account holder.
